(19) United States
(12) Patent Application Publication
(10) Pub. No.: US 2020/0346675 A1
(43) Pub. Date: Nov. 5, 2020

(54) ARRANGEMENT OF PARALLEL MAINTENANCE LINES FOR RAILWAY WAGONS

(71) Applicant: SOUTHWEST JIAOTONG UNIVERSITY, Chengdu (CN)

(72) Inventors: Zeqiang ZHANG, Chengdu (CN); Lixia ZHU, Chengdu (CN); Silu LIU, Chengdu (CN); Ying ZHANG, Chengdu (CN); Yanqing ZENG, Chengdu (CN)

(21) Appl. No.: 16/739,037

(22) Filed: Jan. 9, 2020

(30) Foreign Application Priority Data
Jan. 15, 2019 (CN) 201910036901.9

(51) Int. Cl. B61L 27/00; G06N 7/00

(52) U.S. Cl. CPC B61L 27/0027; G06N 7/00; B61L 27/0066; B61L 27/0072

(57) ABSTRACT

Disclosed is a method for arranging parallel maintenance lines for railway wagons, including: (1) obtaining design information of the parallel maintenance lines; (2) initially designing the parallel maintenance lines; where the maintenance lines comprise a disassembly line and an assembly line parallel to each other, and the disassembly line and the assembly line are connected through a track; (3) establishing a multi-objective mathematical model for solving a parallel maintenance line balancing problem, where the multi-objective mathematical model comprises a first model for minimizing the number of workstations, a second model for minimizing an idle time of the workstations and a third model for minimizing the number of maintenance resources; and (4) obtaining a feasible solution using an intelligent optimization algorithm.

### CROSS-REFERENCE TO RELATED APPLICATIONS

This application claims the benefit of priority from Chinese Patent Application No. 201910036901.9, filed on Jan. 15, 2019. The content of the aforementioned application, including any intervening amendments thereto, is incorporated herein by reference in its entirety.

### TECHNICAL FIELD

This application relates to industrial maintenance lines, and more particularly to an arrangement of parallel maintenance lines for railway wagons.

### BACKGROUND OF THE INVENTION

With the continuous development of the railway transportation network, especially the high-speed railways, it is of considerable importance to ensure the safe operation of railway vehicles. Among the various approaches to ensure the safe operation of railway vehicles, maintenance plays an effective role in maintaining various parts of the railway vehicles in good quality and ensuring the uninterruptedly safe and smooth operation of the railway vehicles. Since the demand for railway vehicles continues to increase, how to improve the maintenance efficiency and quality, and simultaneously minimize the maintenance costs to increase the maintenance profits have become a problem to be solved for every maintenance enterprise.

Railway wagons require periodic maintenance. In the maintenance lines, wagons to be repaired rhythmically move following prescribed routes to pass several repair positions with clear division of work to complete the whole maintenance. In this process, each repair position can be equipped with high-efficiency special equipment and workers have clear divisions of labor, which not only improves the efficiency, but also ensures the repair quality of, enabling the smooth production. The entire process includes disassembly and assembly of wagon parts.

The maintenance line balancing problem is NP (Non-Deterministic Polynomial)-hard combination optimization problem which is more complex than an ordinary assembly line balancing problem. The complexity of such problem increases exponentially with the increase of the scale of the problem. Currently, meta-heuristic algorithms such as genetic algorithm, simulated annealing algorithm and ant colony algorithm are commonly used to solve such problems, but these algorithms all have problems of poor convergence, long search time and low quality. Therefore, it is needed to find a more effective method to deal with the maintenance line balancing problem.

At present, researches on the maintenance lines are performed mostly based on personal experience of staff using a heuristic method. A Chinese Patent Application No. 201310697506.8 discloses a cost-oriented balancing method for mixed-model two-sided assembly lines, where a hybrid colonial competitive algorithm is adopted, which effectively improves the algorithm search performance to obtain a better solution compared with ordinary colonial competitive algorithms and genetic algorithms.

Another Chinese Patent Application No. 201711493844.4, titled Multi-Objective Mixed-Model Two-Sided Assembly Line Balancing Method Based on Migrating Birds Optimization Algorithm, constructs a mathematical model aiming at minimizing the number of stations, load balancing, and unit cost to solve the assembly line balancing problem, and also provides a multi-objective hybrid migrating birds algorithm to solve such problems.

### SUMMARY OF THE INVENTION

An object of the invention is to provide a method for arranging parallel maintenance lines for railway wagons to overcome the problems in the prior art, where this method can minimize the number of workstations, a maintenance line idle time and the number of maintenance resources to achieve the optimization of the parallel maintenance line balancing problem of for railway wagons.

To achieve the above object, the invention provides a method for arranging parallel maintenance lines for railway wagons, comprising:

(1) obtaining design information of the parallel maintenance lines;

(2) initially designing the parallel maintenance lines; wherein the maintenance lines comprise a disassembly line and an assembly line parallel to each other, and the disassembly line and the assembly line are connected through a track;

(3) establishing a multi-objective mathematical model for solving a parallel maintenance line balancing problem, wherein the multi-objective mathematical model comprises a first model for minimizing the number of workstations, a second model for minimizing an idle time of the workstations and a third model for minimizing the number of maintenance resources; and

(4) obtaining a feasible solution using an intelligent optimization algorithm.

The arrangement method of the invention has a simple process, and is capable of solving the multi-objective balancing problem of the parallel maintenance lines for railway wagons to improve the efficiency and reduce the cost of the maintenance. Firstly, the invention establishes a multi-objective mathematical model for minimizing the number of workstations, an idle time of the maintenance lines and the number of maintenance resources to reasonably assigns various maintenance tasks on the maintenance lines, so that load of maintenance staff in respective workstations is balanced as much as possible, and tasks involving the use of the same maintenance resource are assigned to the same workstation as much as possible, maximally utilizing the maintenance resources to reduce maintenance cost and improve the maintenance efficiency. Moreover, the invention adopts an intelligent algorithm to obtain solutions, which enables the arrangement of the maintenance lines to be more similar to the actual work site, achieving an improved effect.

The invention will be further described below with reference to the accompanying drawings and embodiments. These embodiments are intended to make the additional aspects and advantages of the invention clearer and better understood.

### BRIEF DESCRIPTION OF THE DRAWINGS

The drawings are not intended to limit the invention, but for better understanding of the invention.

FIG. 1 is a flow chart of an improved migrating birds algorithm according to an embodiment of the present invention.

FIG. 2 schematically shows an embedded operation according to the embodiment of the present invention.

FIG. 3 schematically shows a crossover operation according to the embodiment of the present invention.

FIG. 4 schematically shows a precedence relationship of maintenance operations for a bogie according to an embodiment of the present invention.

FIG. 5 schematically shows the task assignment according to a solution obtained in an embodiment of the present invention.

### DETAILED DESCRIPTION OF EMBODIMENTS

The invention will be clearly and completely illustrated below with reference to the accompanying drawings. Those skilled in the art are able to achieve the invention based on the following descriptions. It should be noted that technical solutions and features provided below can be combined with each other without conflicts.

In addition, provided below are merely preferred embodiments of the invention, which are not intended to limit the invention. Therefore, based on the embodiments provided herein, any other embodiments obtained by those skilled in the art without paying any creative efforts should fall within the scope of the invention.

As used herein, the terms “include”, “comprise” and any variations thereof in the description and claims of the invention indicate the non-exclusive inclusion.

The invention provides a method for arranging parallel maintenance lines for railway wagons, which is specifically described as follows.

(1) Design information of the parallel maintenance lines is obtained. The design information includes maintenance task information and maintenance resource information. The maintenance task information includes the number and specification of products to be repaired, and disassembly precedence and assembly precedence for the products to be repaired; the maintenance resource information includes maintenance equipment, carrying slings and maintenance tools.
(2) The parallel maintenance lines are initially designed. The maintenance lines include a disassembly line and an assembly line parallel to each other, and the disassembly line and the assembly line are connected through a track.

(3) A multi-objective mathematical model is established for solving a balancing problem of the disassembly-assembly parallel maintenance line, where the establishment is specifically described below.

(3.1) Basic assumptions are determined:

(3.1.1) there are sufficient supply of products to be repaired on the disassembly line and sufficient supply of components and parts, which have undergone maintenance, on the assembly line;

(3.1.2) uncertainty in operations of maintenance workers is ignored, that is, operation time of the disassembly and assembly tasks are certain and known;

(3.1.3) one maintenance worker is assigned to one parallel workstation, and the maintenance workers are multi-skilled and qualified for any operation tasks on the maintenance lines; and

(3.1.4) the maintenance worker walking time between the two maintenance lines are ignored.

(3.2) Variables and parameters are defined.

| Symbol | Meaning |
|---|---|
| i, f | Serial number of respective assembly tasks, ^{i, f ∈{1, 2, . . . , I}} |
| j, h | Serial number of respective disassembly tasks, ^{j, h ∈} ^{{1, 2, . . . , J}} |
| k | Serial number of respective workstations, ^{k ∈} ^{{1, 2, . . . , K}} |
| r | Serial number of respective resource types, ^{r ∈} ^{{1, 2, . . . , R}} |
| C | Takt time of workstation k |
| tₐᵢ | Operation time of assembly task i |
| t_{dj} | Operation time of disassembly task j |
| TSr | A set of tasks using resource r |
| Zₖ | binary variable, if workstation k is open, Zₖ = 1, if not. Zₖ = 0 |
| TTₖ | Operation time of workstation k |
| dⱼₖ | binary variable, if disassembly task j is assigned to workstation k, dⱼₖ = 1; if not, dⱼₖ = 0 |
| aᵢₖ | binary variable; if assembly task i is assigned to workstation k, aᵢₖ = 1; if not, aᵢₖ = 0 |
| Mᵣₖ | binary variable; if resource r is assigned to workstation k, Mᵣₖ = 1, if not, Mᵣₖ = 0 |
| PA | Matrix of a priority relation of assembly tasks PA = [PA_{if}]_{I×I}, if assembly task i is a |
| | Immediate predecessor task of assembly task f, PA_{if} = 1; if not, PA_{if} = 0 |
| PD | Matrix of a priority relation of disassembly tasks PD = [PDⱼₕ]_{J×J}, if disassembly task |
| | j is a Immediate predecessor task of disassembly task h, PDⱼₕ = 1; if not, PDⱼₕ = 0 |

(3.3) A first model for minimizing the number of workstations, a second model for minimizing an idle time of the workstations and a third model for minimizing the number of maintenance resources are established.

The first model is min

$${f}_{1} = {\sum }_{k = 1}^{K} {Z}_{k} ;$$

the second model is min

$${f}_{2} = {\sum }_{k = 1}^{K} {( C \cdot {Z}_{k} - {TT}_{k} )}^{2} ;$$

the third model is min

$${f}_{3} = {\sum }_{r = 1}^{R} {\sum }_{k = 1}^{K} {M}_{rk} .$$

(3.4) Constraints are determined:

(3.4.1)

$${\sum }_{k = 1}^{K} {ka}_{ik} \leq {\sum }_{k = 1}^{K} {ka}_{fk} ,$$

∀PA_{if}=1, which indicates that the assembly tasks are assigned according to a priority relation thereof.

(3.4.2)

$${\sum }_{k = 1}^{K} {kd}_{jk} \leq {\sum }_{k = 1}^{K} {kd}_{hk} ,$$

∀PDⱼₕ=1, which indicates that the disassembly tasks are assigned according to a priority relation thereof.

(3.4.3)

$${\sum }_{k = 1}^{K} {a}_{ik} = 1 ∀ i ∈ \{ 1 , 2 , ⋯ , I \} ,$$

which indicates tat each of the assembly tasks is inseparable and is only allowed to be assigned to one workstation.

(3.4.4)

$${\sum }_{k = 1}^{K} {d}_{jk} = 1 ∀ i ∈ \{ 1 , 2 , ⋯ , J \} ,$$

which indicates that each of the disassembly tasks is inseparable and is only allowed to be assigned to one workstation.

(3.4.5) TTₖ≤C·Zₖ,

$${TT}_{k} = {\sum }_{i = 1}^{I} {a}_{ik} \cdot {t}_{ai} + {\sum }_{j = 1}^{J} {d}_{jk} \cdot {t}_{dj} ∀ k ∈ \{ 1 , 2 , ⋯ , K \} ,$$

which indicates that the operation time of respective workstations is a sum of operation time of assembly and disassembly tasks assigned to the workstation, and a sum of operation time of the workstations is not allowed to exceed a preset takt time of the maintenance lines.

(3.4.6)

$${\sum }_{i = 1}^{I} {a}_{ik} - {IZ}_{k} \leq 0 ∀ k ∈ \{ 1 , 2 , ⋯ , K \} ,$$

which indicates that the number of assembly tasks assigned to the workstation k is not more than a sum of the assembly tasks.

(3.4.7)

$${\sum }_{j = 1}^{J} {d}_{jk} - {JZ}_{k} \leq 0 ∀ k ∈ \{ 1 , 2 , ⋯ , K \} ,$$

which indicates that the number of disassembly tasks assigned to the workstation k is not more than a sum of the disassembly tasks.

(3.4.8) Zₖ₋₁≥Zₖ ∀k∈{2, 3, . . . , K}, which indicates that the workstations are opened in sequence and all assigned with tasks.

(3.4.9)

$${\sum }_{j ∈ {TS}_{r}} {d}_{jk} - ‖ {TS}_{r} ‖ {M}_{rk} \leq 0 ∀ r ∈ \{ 1 , 2 , ⋯ , R \} ,$$

which indicates that if an assembly task i using a resource r is assigned to the workstation k, the workstation k must be equipped with the corresponding resource r.

(3.4.10)

$${\sum }_{i ∈ {TS}_{r}} {a}_{ik} - ‖ {TS}_{r} ‖ {M}_{rk} \leq 0 ∀ r ∈ \{ 1 , 2 , ⋯ , R \} ,$$

which indicates that if a disassembly task j using the resource r is assigned to the workstation k, the workstation k must also be equipped with the corresponding resource r.

(4) A feasible solution is obtained using an improved intelligent optimization algorithm.

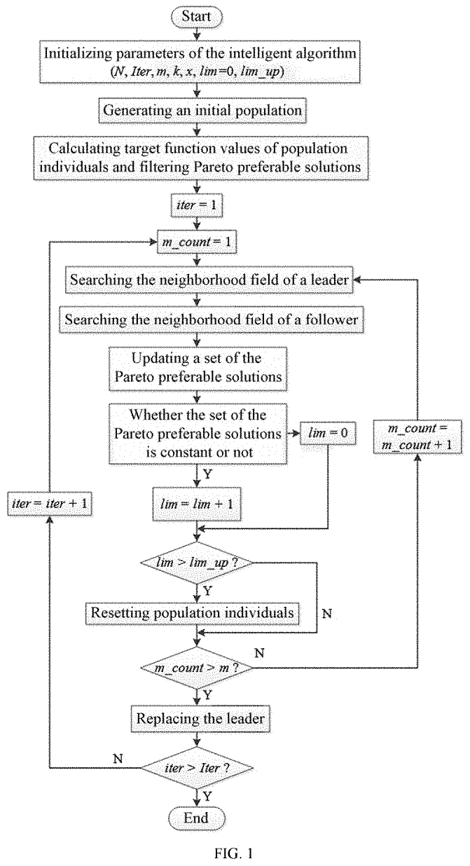

The improved intelligent algorithm is an improved migrating birds algorithm as shown in FIG. 1, which uses a software Matlab. Firstly, initial population individuals of migrating birds are generated through a heuristic algorithm merging designing and characteristics of a problem to be solved, which guarantees quality and diversity of the initial population individuals. The heuristic algorithm means that an initial population is generated through a combination of a random generation algorithm with a position weight heuristic algorithm. Then optimal imbedding operations are employed in the searching of neighborhood fields of a leader and followers, which allows respective population individuals to search for a preferable solution in a current neighborhood thereof. After several neighborhood search optimization operations for each of the population individuals, if a filtered Perato preferable individual is identical to the original Perato preferable individual or there is no improvement occurring after the update, one local optimal count is counted, if the local optimal count is greater than a certain value lim_up, the population individuals are reset.

As shown in FIG. 1, step (4) includes the following steps.

(4.1) Parameters of the intelligent algorithm are initialized: the number N of population, the number Iter of iterations of the intelligent algorithm, the number m of tours, the number k of individual neighborhood solutions of a population, the number x of individual shared neighborhood solutions, a local optimal count lim, an upper limit lim_up of the local optimal count.

(4.2) An initial population Pop is randomly generated through a combination of a random generation algorithm with a position weight heuristic algorithm, target function values of population individuals are calculated and Pareto preferable solutions are filtered.

The improved migrating birds algorithm is a swarm intelligence algorithm based on population optimization, where respective migrating birds in the population represents a feasible solution to a problem optimization space. The population initialization generates the same number of feasible solutions as that of the initial population individuals. In order to ensure the quality of the initial population, accelerate the convergence of the algorithm and consider the diversity maintenance of the population, in step (4.2), the initial population is equiprobably and randomly generated through a combination of a random generation algorithm with a position weight heuristic algorithm according to the precedence between the maintenance tasks (the assembly tasks and the disassembly tasks). Specific pseudo code of the initial population generation is shown as follows.

The number T of tasks, a matrix PD of a priority relation of disassembly tasks, a matrix PA of a priority relation of assembly tasks and the number N of the population individuals are input.

(4.2.1) For i=1 to N

(4.2.2) A random number r is generated.

(4.2.3) If r<0.5

(4.2.4) For j=1 to TS

(4.2.5) According to PD and PA, all disassembly tasks whose Immediate predecessor tasks are empty or have been assigned and assembly tasks whose Immediate successor tasks are empty or have been assigned are found out at the same time, that is, all tasks in PD whose all row elements have a sum of 0 and in PA whose all column elements have a sum of 0 are found out respectively and form a set CS of tasks to be assigned.

(4.2.6) A task t is randomly selected in CS and assigned to a current position sequences of a current individual Pop_i.

(4.2.7) If the task t is an assembly task, a column element of the task t in PA is set to 0, and a row element thereof is set to 1, if not, a row element of the task t in PD is set to 0, and a column element thereof is set to 1.

(4.2.8) End For

(4.2.9) Else If r>=0.5

(4.2.10) For j=1 to TS

(4.2.11) According to PD and PA, all disassembly tasks whose Immediate predecessor tasks are empty or have been assigned and assembly tasks whose Immediate successor tasks are empty or have been assigned are found out at the same time, that is, all tasks in PD whose all row elements have a sum of 0 and in PA whose all column elements have a sum of 0 are found out respectively and form a set CS of tasks to be assigned.

(4.2.12) A task t is randomly selected in CS and assigned to a current position sequences of a current individual Pop_i.

(4.2.13) If the task t is an assembly task, a column element of the task t in PA is set to 0, and a row element thereof is set to 1, if not, a row element of the No. t task in PD is set to 0, and a column element thereof is set to 1.

(4.2.14) End For

(4.2.15) End If

(4.2.16) End For

The initial population Pop and the number N of the population individuals are output.

(4.3) An iteration count iter is set to 1, and the iterations of the intelligent algorithm start.

(4.4) A tour count m_count is set to 1.

(4.5) A leader searches a neighborhood field, and after the leader is self-improved, shares remaining x optimal neighborhood solutions with two first followers respectively next to the leader at left and right sides in a V-shaped formation.

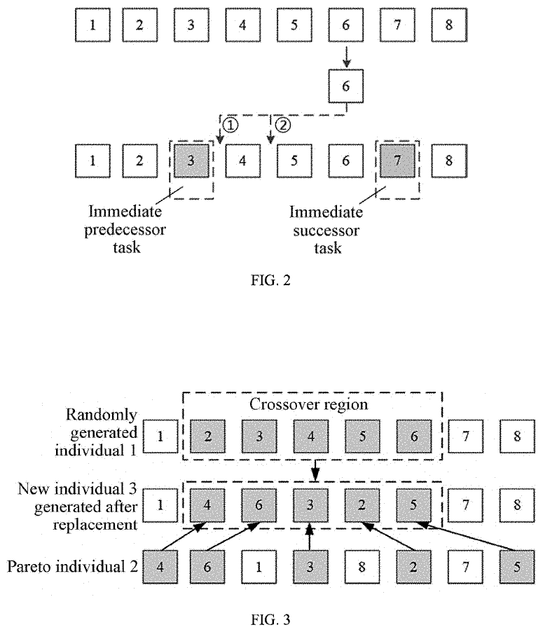

The searching a neighborhood field of respective population individuals runs through the entire process of a basic migrating birds optimization algorithm, so it is crucial to choose an effective neighborhood search operation to improve the performance of the migrating birds optimization algorithm. Therefore, step (4.5) adopts an optimal embedded operation to realize the neighborhood search operation of the population individuals, and the embedded operation mechanism is shown as FIG. 2. For example, a task 6 is randomly chosen in the current solution sequence. It is assumed that the task 6 task is an assembly task, so according to PA, a task 3 and a task 7 are determined to be the front and Immediate successor tasks thereof, respectively. It is known that the task 6 can be inserted in any of positions \textcircled{1} and \textcircled{2} indicated by dashed arrows, and a neighborhood solution is generated. If the chosen task is a disassembly task, similarly, the front and Immediate successor tasks thereof are determined according to PD, and then insertable positions thereof are determined. The leader generates TS new solutions through the embedded operation mentioned above, where k optimal solutions are selected to be k neighborhood solutions of the current solution, after a self-improvement, the remaining x optimal neighborhood solutions are shared with two first followers respectively next to the leader at left and right sides in a V-shaped formation. After that, each of two first followers respectively next to the leader at left and right sides in a V-shaped formation generates k-x neighborhood solutions through an optimal embedded operation, similarly, after a self-improvement, the remaining x optimal neighborhood solutions are shared with two second followers respectively at the left and right sides of the V-shaped formation, until the last follower respectively at the left and right sides of the V-shaped formation complete the self-improvement.

(4.6) Respective first followers searches a neighborhood field to generates k-x neighborhood solutions; and after the first followers are self-improved, the remaining x optimal neighborhood solutions are shared respectively with two second followers.

(4.7) When the last followers respectively at the left and right sides of the V-shaped formation complete the self-improvement, one tour is completed, the target function values are calculated and a set of the Pareto preferable solutions is updated.

(4.8) The updated set of the Pareto preferable solutions is compared with the set of the Pareto preferable solutions before the updating by calculating a Hypervolume index, if the Hypervolume index is constant, one local optimal count is counted, that is, lim=lim+1, if not, lim=0;

(4.9) If the local optimal count lim is greater than the upper limit lim_up thereof, the population individuals are reset.

The basic migrating birds optimization algorithm is performed based on the neighborhood search of the population individuals. Specifically, during the operation of the algorithm, the search is continuously performed in the direction of one or several neighborhood fields, and preferable solutions are continuously accepted at the same time, which will easily cause the basic migrating birds optimization algorithm to fall into a local optimum. To avoid the defect and accelerate the global optimization, a reset mechanism for the population individuals is provided in the improved migrating birds optimization algorithm used in step (4.9).

Specifically, after all individuals in the population undergo a self-improvement, the Pareto preferable solutions are filtered and updated. If the updated Perato preferable solution is identical to the original Perato preferable solution or there is no improvement occurring after the update, one local optimal count is counted, that is, lim=lim+1, if not, lim=0. Once the local optimal count is greater than the upper limit lim_up, the population individuals will be reset.

Since the maintenance line balancing problem investigated herein is a multi-objective problem, there are several Perato preferable solutions included in the Perato preferable solution set generated from every iteration of the algorithm, and it fails to directly determine whether one Perato preferable solution set is better or worse than another Perato preferable solution set. Therefore, the Hypervolume index is introduced herein to process the comparison of the multi-objective optimization results, specifically, the Hypervolume index evaluates a solution set by comparing volumes of target spaces dominated by the Perato preferable solution sets, that is, the solution set is better if the volume of the target space dominated thereby is larger. Therefore, whether there are differences existing in the Pareto preferable solution sets before and after the update can be determined by calculating and comparing the corresponding Hypervolume indexes, if the Hypervolume index is constant, one local optimal count is counted, that is, lim=lim+1, if not, lim=0. Once the local optimal count lim is greater than the upper limit lim_up thereof, the population individuals will be reset. The reset is performed via the crossover operation between the randomly generated individuals and the current Pareto preferable solution individuals, and the crossover operation is shown in FIG. 3.

As shown in FIG. 3, two crossover points are randomly selected on a randomly generated individual 1. The two crossover points together with the task sequence therebetween form a crossover region, as shown in a dashed line box in the individual 1. A Pareto individual 2 is randomly selected among the current Pareto preferable solution set, and the task sequences in the crossover region of the individual 1 are successively replaced with the task sequences in the Pareto individual 2 mapped to the task sequences in the crossover region of the individual 1 to generate a new individual 3, which ensures the new individual to meet the precedence of the tasks by inheriting excellent partial sequences from the Pareto individual 2. Through this crossover operation, all population individuals are reset. The reset mechanism not only achieves the expansion of the optimizing space, but also ensures the inheritage of characteristics of the current optimal individual, which avoids torturous searches and accelerates global convergence of the algorithm.

(4.10) If the tour count m_count>m, the leader moves to a tail end of each of the left and right sides of the V-shaped formation to becomes a follower, so that the first follower at the corresponding side becomes a new leader and the remaining followers successively moves forward by one position and the process proceeds to step (4.11), if not, m_count=m_count+1, the process returns to step (4.5).

(4.11) If the iteration count iter≤Iter, iter=iter+1, the process returns to step (4.4), if not, the process proceeds to step (4.12).

(4.12) The intelligent algorithm comes to an end.

### Example 1

Maintenance lines for the bogie are optimized herein. There are 26 tasks (i.e., n=26), including 14 disassembly tasks (Nos. 1-14) and 12 assembly tasks (Nos. 15-26). The information of the tasks of such bogie maintenance lines is specifically shown in Table 1, and the takt time of each of workstations is 150 s.

TABLE 1
Information of tasks of the bogie maintenance lines

| | | Operation | Disassembly |
|---|---|---|---|
| No. | Task | time/s | resource |
| 1 | Disassembly of inclined wedge, | 72 | Null |
| | bolster spring and damping spring | | |
| 2 | Disassembly of fastener | 48 | Electric drill |
| 3 | Disassembly of adapter | 16 | Null |
| 4 | Disassembly of fixed lever | 10 | Hammer |
| 5 | Disassembly of floating lever | 137 | Hammer |
| 6 | Disassembly of middle pull rod | 23 | Null |
| 7 | Disassembly of round pin and high | 11 | Wrench |
| | friction composite brake shoe | | |
| 8 | Disassembly of center wear plate | 10 | Remover tools |
| 9 | Disassembly of cross beam | 5 | Electric drill |
| 10 | Disassembly of brake beam | 41 | Trolley conveyor |
| 11 | Disassembly of lower center plate | 108 | Electric drill, |
| | | | wrench, crane |
| 12 | Disassembly of center wear pad | 2 | Null |
| 13 | Disassembly of bogie side bearing | 14 | Wrench |
| 14 | Inspection of bolster and | 78 | Flaw detection |
| | side frame | | machine |
| 15 | Assembly of bogie side bearing | 60 | Wrench |
| 16 | Painting of center wear pad | 14 | Null |
| 17 | Assembly of lower center plate | 81 | Electric drill, crane |
| 18 | Assembly of cross beam | 110 | Electric drill |
| 19 | Inspection of friction surface of | 63 | Flaw detection |
| | bolster and inclined wedge | | machine |
| 70 | Assembly of spring and combined | 54 | Null |
| | inclined wedge | | |
| 21 | Assembly of fixed lever | 35 | Hammer |
| 72 | Assembly of high friction | 99 | Wrench |
| | composite brake shoe | | |
| 73 | Assembly of adapter | 16 | Null |
| 24 | Assembly of brake beam | 64 | Trolley conveyor |
| 25 | Assembly of middle pull rod | 17 | Null |
| 26 | Assembly of fastener | 63 | Electric drill |

The priority relation of the 26 tasks is shown in FIG. 4, and a matrix PA of the priority relation of the assembly tasks is obtained as follows:

$$PA = [ \begin{matrix}0 & 1 & 0 & 0 & 0 & 0 & 0 & 0 & 0 & 0 & 0 & 0 \\ 0 & 0 & 1 & 0 & 0 & 0 & 0 & 0 & 0 & 0 & 0 & 0 \\ 0 & 0 & 0 & 0 & 1 & 0 & 0 & 0 & 0 & 0 & 0 & 0 \\ 0 & 0 & 0 & 0 & 1 & 0 & 0 & 0 & 0 & 0 & 0 & 0 \\ 0 & 0 & 0 & 0 & 0 & 1 & 1 & 0 & 1 & 0 & 0 & 0 \\ 0 & 0 & 0 & 0 & 0 & 0 & 0 & 0 & 0 & 0 & 0 & 0 \\ 0 & 0 & 0 & 0 & 0 & 0 & 0 & 1 & 0 & 0 & 0 & 0 \\ 0 & 0 & 0 & 0 & 0 & 0 & 0 & 0 & 0 & 1 & 0 & 0 \\ 0 & 0 & 0 & 0 & 0 & 0 & 0 & 0 & 0 & 0 & 0 & 0 \\ 0 & 0 & 0 & 0 & 0 & 0 & 0 & 0 & 0 & 0 & 1 & 0 \\ 0 & 0 & 0 & 0 & 0 & 0 & 0 & 0 & 0 & 0 & 0 & 1 \\ 0 & 0 & 0 & 0 & 0 & 0 & 0 & 0 & 0 & 0 & 0 & 0\end{matrix} ] .$$

A matrix PD of the priority relation of the disassembly tasks is obtained as follows:

$$PD = [ \begin{matrix}0 & 0 & 0 & 0 & 0 & 0 & 0 & 0 & 0 & 0 & 0 & 0 & 0 & 0 \\ 0 & 0 & 0 & 1 & 1 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 \\ 0 & 0 & 0 & 0 & 0 & 0 & 1 & 0 & 0 & 0 & 0 & 0 & 0 & 0 \\ 0 & 0 & 0 & 0 & 0 & 1 & 0 & 0 & 0 & 0 & 0 & 0 & 0 & 0 \\ 0 & 0 & 0 & 0 & 0 & 0 & 0 & 1 & 0 & 0 & 0 & 0 & 0 & 0 \\ 0 & 0 & 0 & 0 & 0 & 0 & 0 & 0 & 1 & 0 & 0 & 0 & 0 & 0 \\ 0 & 0 & 0 & 0 & 0 & 0 & 0 & 0 & 0 & 0 & 1 & 0 & 0 & 0 \\ 0 & 0 & 0 & 0 & 0 & 0 & 0 & 0 & 0 & 1 & 0 & 0 & 0 & 0 \\ 0 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 0 & 0 & 1 & 0 & 0 \\ 0 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 1\end{matrix} ] .$$

Then, a pseudocode is run to determine the related parameters, where the number N of population is 51, the number Iter of iterations is 700, the number m of tours is 10, the number k of individual neighborhood solutions is 3, the number x of individual shared neighborhood solutions is 1 and an upper limit lim_up of a local optimal count is 10.

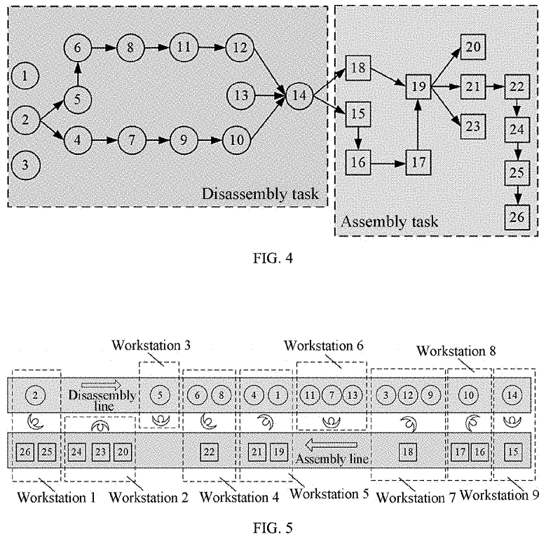

The improved migrating birds optimization algorithm provided in FIG. 1 is run to generate a task assignment corresponding to one solution, which is schematically shown in FIG. 5. As shown in FIG. 5, on the premise of meeting various constraints, there are only 9 workstations, where disassembly task 2 and assembly tasks 25-26 are assigned to the workstation 1; assembly tasks 20 and 23-24 are assigned to a workstation 2; workstation 3 is only responsible for disassembly task 5 because of longer time consumption; disassembly tasks 6 and 8 and assembly task 22 are assigned to workstation 4; disassembly tasks 4 and 1 and assembly tasks 21 and 19 are assigned to workstation 5; disassembly tasks 11, 7 and 3 are assigned to workstation 6; disassembly tasks 3, 12 and 9 and assembly task 18 are assigned to a workstation 7; disassembly task 10 and assembly tasks 16-17 are assigned to workstation 8; and disassembly task 14 and assembly task 15 are assigned to workstation 9.

Obviously, the 26 tasks of the bogie maintenance lines are assigned reasonably herein, which ensures that the workload of the maintenance staff in respective workstations can be balanced as much as possible; and the tasks involving the use of the same maintenance resource are assigned to the same workstation as much as possible, so that the maintenance resources are maximally utilized, the maintenance cost is reduced, the maintenance line idle time is minimized and the number of maintenance resources is minimized, greatly improving the maintenance efficiency.

The above-mentioned embodiments are merely illustrative of the invention. Those skilled in the art will be able to implement the invention based on the contents disclosed herein. Any other embodiments obtained by those skilled in the art without departing from the spirit of the invention should fall within the scope of the invention.

What is claimed is:

1. A method for arranging parallel maintenance lines for railway wagons, comprising:
(1) obtaining design information of the parallel maintenance lines;
(2) initially designing the parallel maintenance lines; wherein the maintenance lines comprise a disassembly line and an assembly line parallel to each other, and the disassembly line and the assembly line are connected through a track;
(3) establishing a multi-objective mathematical model for solving a parallel maintenance line balancing problem, wherein the multi-objective mathematical model comprises a first model for minimizing the number of workstations, a second model for minimizing an idle time of the workstations and a third model for minimizing the number of maintenance resources; and
(4) obtaining a feasible solution using an intelligent optimization algorithm.

2. The method of claim 1, wherein the design information comprises maintenance task information and maintenance resource information.

3. The method of claim 2, wherein the maintenance task information comprises: the number and specification of products to be repaired, and disassembly precedence and assembly precedence for the products to be repaired; and the maintenance resource information comprises maintenance equipment, lifting devices and maintenance tools.

4. The method of claim 1, wherein in step (3),
the first model is min
$${f}_{1} = {\sum }_{k = 1}^{K} {Z}_{k} ;$$
the second model is min
$${f}_{2} = {\sum }_{k = 1}^{K} {( C \cdot {Z}_{k} - {TT}_{k} )}^{2} ;$$
and
the third model is min
$${f}_{3} = {\sum }_{r = 1}^{R} {\sum }_{k = 1}^{K} {M}_{rk} ;$$
wherein K is the number of the workstations; k is a serial number of respective workstations, k∈{1, 2, . . . , K}; Zₖ is a binary variable, if a workstation k is open, Zₖ=1, if not, Zₖ=0; TTₖ is an operation time of the workstation k; C is a takt time of the workstation k; R is the number of resource types; r is a serial number of respective resource types, r∈{1, 2, . . . , R}; Mᵣₖ is a binary variable, if a resource type r is assigned to the workstation k, Mᵣₖ=1, if not, Mᵣₖ=0.

5. The method of claim 4, wherein step (3) is performed under the following assumptions:
(1) there are sufficient supply of products to be repaired on the disassembly line and sufficient supply of components and parts, which have undergone maintenance, on the assembly line;
(2) uncertainty in operations of maintenance workers is ignored, that is, operation time of the disassembly and assembly tasks are certain and known;
(3) one maintenance worker is assigned to one parallel workstation, and the maintenance workers are multi-skilled and qualified for any operation tasks on the maintenance lines; and
(4) the maintenance worker walking time between the two maintenance lines are ignored.

6. The method of claim 4, wherein step (3) is performed under the following constraints:
(1) the assembly tasks are assigned according to the precedence thereof;
(2) the disassembly tasks are assigned according to the precedence thereof;
(3) each of the assembly tasks is inseparable and is only allowed to be assigned to one workstation;
(4) each of the disassembly tasks is inseparable and is only allowed to be assigned to one workstation;
(5) the operation time of respective workstations is a sum of operation time of assembly and disassembly tasks assigned to the workstation, and a sum of operation time of the workstations is not allowed to exceed a preset takt time of the maintenance lines;
(6) the number of assembly tasks assigned to the workstation k is not more than a sum of the assembly tasks;
(7) the number of disassembly tasks assigned to the workstation k is not more than a sum of the disassembly tasks;
(8) the workstations are opened in sequence and all assigned with tasks;
(9) if an assembly task i using a resource r is assigned to the workstation k, the workstation k must be equipped with the corresponding resource r; and
(10) if a disassembly task j using the resource r is assigned to the workstation k, the workstation k must also be equipped with the corresponding resource r.

7. The method of claim 1, wherein the intelligent optimization algorithm is an improved migrating birds algorithm.

8. The method of claim 7, wherein step (4) comprises:
(1) initializing parameters of the intelligent optimization algorithm, wherein the parameters comprises: the number N of population, the number Iter of iterations of the intelligent algorithm, the number m of tours, the number k of individual neighborhood solutions of a population, the number x of individual shared neighborhood solutions, a local optimal count lim, an upper limit lim_up of the local optimal count;
(2) generating an initial population Pop; calculating target function values of population individuals and filtering Pareto preferable solutions;
(3) setting an iteration count iter to 1 and starting the iteration of the intelligent algorithm;
(4) setting a tour count m_count to 1;
(5) searching a neighborhood field of a leader, and after the leader is self-improved, sharing remaining x optimal neighborhood solutions with two first followers respectively next to the leader at left and right sides in a V-shaped formation;
(6) searching a neighborhood field of respective first followers to generate k-x neighborhood solutions; and after the first followers are self-improved, sharing the remaining x optimal neighborhood solutions respectively with two second followers;
(7) completing one tour when the last followers respectively at the left and right sides of the V-shaped formation complete the self-improvement; calculating the target function values and updating a set of the Pareto preferable solutions;
(8) comparing the updated set of the Pareto preferable solutions with the set of the Pareto preferable solutions before updating by calculating a Hypervolume index, wherein if the Hypervolume index is constant, one local optimal count is counted, lim=lim+1, if not, lim=0;
(9) resetting the population individuals if the local optimal count lim is greater than the upper limit lim_up thereof;
(10) if the tour count m_count>m, allowing the leader to move to a tail end of each of the left and right sides of the V-shaped formation to become a follower, so that the first follower at the corresponding side becomes a new leader and the remaining followers successively moves forward by one position, and proceeding to step (11), if not, m_count=m_count+1, returning to step (5);
(11) if the iteration count iter≤Iter, iter=iter+1, returning to step (4), if not, proceeding to step (12); and
(12) ending the intelligent algorithm.

9. The method of claim 8, wherein in step (2), the initial population is randomly generated through a combination of a random generation algorithm and a position weight heuristic algorithm.

10. The method of claim 8, wherein in step (5), the searching of neighborhood fields is performed based on a neighborhood search operation based on an optimal embedded mechanism.
